(19) United States
(12) Patent Application Publication
(10) Pub. No.: US 2026/0034686 A1
(43) Pub. Date: Feb. 5, 2026

(54) Work apparatus

(71) Applicant: EFS-Gesellschaft für Hebe- und Handhabungstechnik mbH, Nordheim (DE)

(72) Inventor: Aaron Geenen, Schwaigern-Niederhofen (DE)

(73) Assignee: EFS-Gesellschaft für Hebe- und Handhabungstechnik mbH, Nordheim (DE)

(21) Appl. No.: 19/285,770

(22) Filed: Jul. 30, 2025

(30) Foreign Application Priority Data
Aug. 1, 2024 (EP) 24192336.6

(51) Int. Cl. B25J 19/00; B25J 9/00

(52) U.S. Cl. CPC B25J 19/0012; B25J 9/0081

(57) ABSTRACT

A work apparatus for lifting and moving an external load (1), includes a base body (14), and a gripper (10) for the load (1). The gripper (10) is movable with respect to the base body (14). At least one drive device (52) is configured to move the gripper (10) together with the load (1). A control unit (11) controls the drive device (52). The gripper (10) together with the load (1) is movable by the control unit (11) at least partially automatically by the drive device (52). The work apparatus includes a weight compensation device (24) for absorbing at least some of the weight of the external load (1), in particular during the automatic movement of the load (1) by the drive device (52). The application of force by the weight compensation device (24) is adjustable, in particular by the control unit (11).

### CROSS-REFERENCE TO RELATED APPLICATION

This application claims the benefit of European Patent Application 24192336.6, filed on Aug. 1, 2024, the contents of which is incorporated in its entirety.

### TECHNICAL FIELD

The disclosure relates to a work apparatus for lifting and moving an external load.

### BACKGROUND

Industrial robots which can move loads fully automatically from one point to another by means of gripper arms are known. Large loads may be transported and complex safety precautions must accordingly be taken. A particular potential risk lies in possible collisions between machine and person. When the industrial robot is in operation, the person must therefore stay outside a cordoned-off safety area. If a drive that is responsible for holding and guiding the load fails, the load can cause considerable damage.

### SUMMARY

An object underlying the invention is to create a work apparatus for lifting and moving an external load which enables an external load to be lifted and moved safely and easily.

This object is achieved by a work apparatus as disclosed herein.

A further object of the invention lies in specifying a method for operating a work apparatus for lifting and moving an external load with which an external load can be lifted and moved safely and easily.

This object is achieved by a method as disclosed herein.

Provision is made for the work apparatus to comprise a weight compensation device. The weight compensation device serves to absorb at least some of the weight of the external load. In particular, the weight compensation device serves to absorb at least some of the weight of the external load while the load is being moved by means of the drive device. The drive device is thereby able to move the load from one point to another with very little force. The weight is at least partially, in particular to a very large extent, compensated for by the weight compensation device. The application of force by the weight compensation device is adjustable. In particular, the application of force by the weight compensation device is adjustable by means of the control unit. In particular, the application of force by the weight compensation device is electronically adjustable. In particular, the application of force by the weight compensation device is adjustable by a motor.

Because the weight compensation device absorbs at least some of the weight of the external load, the work apparatus can be operated safely. Because the gripper together with the load is movable by the control unit at least partially automatically by means of the drive device, the external load can easily be lifted and moved by means of the work apparatus. If the drive device fails, the weight of the load is still absorbed by the weight compensation device. The gripper can be moved very safely by means of the drive device since the weight of the load and of the components of the work apparatus are not absorbed or are absorbed only to a minor extent by the drive device. Movement by the drive device can therefore be carried out safely. Only a small amount of energy, in particular only a small amount of force, has to be applied for movement by the drive device. In the event of a fault, in particular if the drive device fails, the potential risk is low. The weight compensation device does not have to be configured to allow any desired three-dimensional movement of the gripper. It is sufficient that the weight compensation device is configured to absorb the force acting in the direction of gravity. This allows a high safety standard to be achieved for the weight compensation device.

Because the weight compensation device absorbs at least some of the weight of the external load, only a very small force is required to move the load. Motors of the drive device can accordingly be configured to be small and cost-effective. In particular, the force required by the drive device to move the gripper together with the load is small in relation to the weight of the load. In the event of a collision between the work apparatus and a worker while the gripper is being moved, in particular together with the load, no particular safety precautions are required due to the only low force required by the drive device to move the gripper, in particular together with the load. In particular, the worker can remain within the working area of the work apparatus. In the event of a collision, the worker only needs to apply the force exerted by the drive device to stop the movement of the work apparatus. Since this force is low, the worker can remain within the working area of the work apparatus even while the gripper is moving, in particular together with the load.

The weight compensation device is expediently designed separately from the drive device. In particular, the weight compensation device and the drive device are designed completely separately from one another. In particular, the weight compensation device and the drive device are two separate drive trains. As a result, the weight compensation and the movement are functionally separate from one another. The work apparatus can therefore be designed so that the drive device does not have to assume any function that is relevant in terms of safety.

In particular, the gripper can be moved in all three spatial directions by means of the drive device. It is expediently possible for the drive device to carry out rotation around three different spatial axes. In particular, the load can be moved in up to six degrees of freedom by means of the drive device. It is expediently possible for exclusively the gripper to be relocated in the direction of gravity by means of the weight compensation device.

In particular, the weight compensation device comprises a motor. The motor is a power machine which carries out mechanical work by converting one form of energy, such as thermal, chemical, hydraulic, pneumatic or electrical energy, into movement energy. The motor does not necessarily have to cause a movement here. The motor can also apply force to hold a load in a certain position. In particular, the motor can counteract the weight.

In particular, the weight compensation device is part of a balance unit. The balance unit serves to absorb the weight of the external load, in particular the work apparatus and the external load. In particular, the balance unit comprises a counterweight. In particular, the counterweight is designed separately from the weight compensation device.

The balance unit, in particular the weight compensation device, advantageously absorbs at least 90%, in particular at least 95%, in particular at least 98%, preferably at least 99% of the weight of the load, in particular of the weight of the load and of the work apparatus. Provision may also be made for the balance unit, in particular the weight compensation device, to absorb 100% of the weight of the load, in particular of the weight of the load and of the work apparatus.

The base body is advantageously mechanically connected by means of at least one structural element to the gripper for lifting and moving of the gripper together with the load. In particular, the component is an arm of the work apparatus. In particular, the component is designed in one part. In particular, the structural element is rigid. In particular, the structural element has no pivot axis. In particular, the structural element is unchanging in its form. However, provision may also be made for the component to comprise a cable and a cable guide which is movable by the drive device. In particular, the cable guide may be a cable pulley.

Advantageously, the gripper can be moved together with the load in a direction of movement by moving the at least one structural element relative to the base body.

In particular, the work apparatus is configured so that the work apparatus, in particular the gripper, can carry out an identical movement both through action of the drive device alone and through action of the weight compensation device alone. This applies in particular to load-free operation of the work apparatus. In particular, the weight compensation device and the drive device can act on one and the same structural element of the work apparatus. In particular, the structural element is movable along a translation axis or about a rotation axis. Expediently, both the weight compensation device and the drive device act at least partially in the direction of movement of one and the same structural element about the rotation axis or along the translation axis of this structural element. When lifting and holding a load, the weight compensation device absorbs the majority of the load's weight, while the drive device is intended to move the load three-dimensionally.

Expediently, the weight compensation device comprises at least one first actuator. In particular, the drive device comprises at least one second actuator. Both the first actuator and the second actuator act directly on the at least one structural element. In particular, both the first actuator and the second actuator are directly supported on the at least one structural element. This allows the first actuator to absorb at least some of the weight of the load, and in particular some of the weight of the work apparatus. At the same time, the structural element can be moved by means of the second actuator. This separation of absorption of the weight and movement of the structural element increases the safety of the work apparatus.

In particular, the structural element is supported on the base body so as to be movable with respect to the base body at least indirectly, in particular directly.

Advantageously, both the first actuator alone and the second actuator alone can act on the at least one structural element such that a force acts on the structural element in the same direction of movement on the at least one structural element through the first actuator alone or through the second actuator alone. The direction of movement runs in particular in a plane that extends in the direction of gravity. Provision may also be made for the direction of movement to run in the direction of gravity.

In an advantageous refinement of the invention, a plurality of structural elements are arranged between the base body and the gripper. The plurality of structural elements are movable with respect to one another. Each structural element is assigned a first actuator and a second actuator. The first actuator and the second actuator each have the properties described above. In particular, adjacent structural elements are each connected to one another by a bearing. In particular, the gripper and the base body are connected exclusively via the plurality of structural elements. In particular, each of the plurality of structural elements is assigned a first actuator and a second actuator. This ensures that the weight is absorbed by the first actuators of the weight compensation device and transferred to the base body. The second actuators of the drive device can cause movement of the gripper with virtually no load from the weight.

Advantageously, on each structural element of the work apparatus which, by means of a joint, can move in the direction of gravity relative to a directly adjacent structural element directly connected via the joint, there is provided a mechanical support device which mechanically couples the two adjacent structural elements to one another to prevent movement of the structural element that is functionally further away from the base body, or at least a first actuator of the weight compensation device and at least a second actuator of the drive device. This ensures that the weight compensation device can absorb all of the weight. In particular, the weight compensation device can pass on all of the weight to the base body. The weight compensation device can therefore support any structural element which can move in the direction of gravity against such a movement and, in particular, prevent such a movement.

In particular, the control unit regulates the application of force by the weight compensation device, in particular the first actuator of the weight compensation device, in particular all first actuators of the weight compensation device, so that a variable of the drive device, in particular of the second actuator of the drive device, in particular of all second actuators of the drive device, is below a threshold value. The variable of the drive device, in particular of the second actuator of the drive device, is also referred to as the operating variable, parameter or key figure of the drive device, in particular of the second actuator of the drive device. The variable of the drive device may, for example, be the strength of the current flowing through the drive device, the drive power of the drive device and/or the force which the drive device must exert to hold and move the load. The threshold value is then a current threshold value, a power threshold value and/or a force threshold value. However, it may also be a torque threshold value or a speed threshold value. In particular, the variable of the drive device is measured directly during regulation by the control unit. In particular, the strength of the current flowing through the drive device, the drive power of the drive device and/or the force which the drive device must apply to hold and move the load are measured directly. The regulation is carried out, in particular, so that the measured variable remains below the threshold value. For this purpose, the application of force by the weight compensation device is expediently adjusted. In particular, the measured variable is fed to the control unit and the control unit adjusts the application of force by the weight compensation device. In particular, the control unit monitors the development of the measured variable here and adjusts the application of force if necessary.

Advantageously, the control unit regulates the application of force by the weight compensation device, in particular by the first actuator, in particular all first actuators of the weight compensation device, so that the force which the drive device, in particular that of the second actuator, in particular of all second actuators of the drive device, must apply to hold and move the load is below a force threshold value. In particular, the force threshold value is 800 N, in particular 700 N, in particular 500 N, in particular 150 N. These values apply in particular to a single second actuator of the drive device. If a plurality of second actuators are provided, the force threshold value corresponds to the sum of the forces which all second actuators of the drive device must apply to hold and move the load. The values already mentioned apply.

The control unit expediently regulates the application of force by the weight compensation device, in particular by the first actuator, in particular all first actuators of the weight compensation device, so that the drive power with which the drive device, in particular the second actuator, in particular all second actuators of the drive device, must be operated to hold and move the load is below a power threshold value. In particular, the power threshold value is 1 kW, in particular 0.8 kW, in particular 0.5 kW, in particular 0.2 kW. These values apply in particular to a single second actuator of the drive device. If a plurality of second actuators are provided, these values are multiplied by the number of second actuators to obtain the power threshold value.

In particular, the control unit regulates the application of force by the weight compensation device, in particular by the first actuator, in particular all first actuators of the weight compensation device, so that the strength of the current flowing through the drive device, in particular through the second actuator, in particular through all second actuators of the drive device, to hold and move the load is below a current threshold value. In particular, the current threshold value is 5 A, in particular 3 A, in particular 2 A, in particular 1 A.

This means that the drive device only needs to apply a small amount of force to hold and move the load.

Advantageously, the nominal power of the second actuator, in particular the sum of the nominal powers of all second actuators of the drive device, is no more than 30%, in particular no more than 20%, in particular no more than 10%, in particular no more than 5% of the nominal power of the first actuator, in particular the sum of the nominal powers of all first actuators of the weight compensation device. This allows powerful motors to be used for the first actuators, which are relevant in terms of safety due to weight compensation, and less powerful motors for the second actuators, which only serve to move the gripper, in particular the load, three-dimensionally. This is cost- and energy-efficient.

In particular, the gripper is movable at least partially automatically by means of the drive device without the assistance of force applied by a worker. This enables the load to be moved easily. The worker does not need to intervene to provide force here. The gripper is expediently positionable into an end position of the gripper by the control unit by means of the drive device. This allows the load to be moved easily into the end position by means of the drive device.

In particular, the gripper is movable, in particular positionable, fully automatically from a starting position of the gripper into an end position of the gripper. This enables particularly easy operation of the work apparatus. The worker does not have to apply any force to move the load from the starting position into the end position.

In particular, the gripper is movable, in particular positionable, fully automatically by the control unit from a starting position of the gripper into an end position of the gripper. This enables easy operation of the work apparatus by means of the control unit.

Advantageously, the work apparatus is configured so that the gripper moves the load fully automatically to a position specified by the control unit without the assistance of force applied by a worker. In particular, the positioning of the gripper can be carried out exclusively by the control unit and the drive device, in particular with a constant application of force by the weight compensation device.

Expediently, the force that can be applied by the drive device to move the gripper together with the load is no more than 800 N, in particular no more than 700 N, in particular no more than 500 N, in particular no more than 150 N. This means that the force, in particular the power, to be applied by the drive device is low. The drive device can be designed simply and inexpensively. When moving the gripper together with the load, the drive device does not have to apply any great force, in particular any force that is relevant in terms of safety.

Advantageously, the force that can be applied by the drive device to move the gripper together with the load is at least 10 N, in particular at least 20 N, in particular at least 30 N.

Advantageously, the work apparatus, in particular the weight compensation device, is configured so that an external load weighing at least 10 kg, in particular at least 30 kg, in particular at least 100 kg, can be held by means of the gripper. In particular, the work apparatus, in particular the weight compensation device, is configured so that an external load weighing no more than 1000 kg, in particular no more than 300 kg, in particular no more than 160 kg, can be held by means of the gripper. In particular, the work apparatus, in particular the weight compensation device, is configured to hold a load from a load range of 10 kg to 1000 kg, in particular from 10 kg to 300 kg, in particular from 30 kg to 1000 kg, in particular from 30 kg to 300 kg, in particular from 30 kg to 160 kg. This makes the work apparatus for lifting and moving an external load also suitable for industrial purposes.

The force that can be applied by the weight compensation device to hold the gripper together with the load is expediently at least 100 N, in particular at least 300 N, in particular at least 1000 N. This means that the majority of the weight is absorbed by the weight compensation device and not by the drive device.

Advantageously, the force that can be applied by the weight compensation device to hold the gripper together with the load is no more than 10,000 N, in particular no more than 3000 N, in particular no more than 1600 N.

In particular, the force that can be applied by the weight compensation device is in a range from 100 N to 10,000 N, in particular from 100 N to 3000 N, in particular from 300 N to 3000 N, in particular from 300 N to 1600 N.

The weight compensation device expediently comprises a motor. In particular, the weight compensation device is a motor. Advantageously, the weight compensation device comprises a pneumatic and/or hydraulic cylinder and/or an electric drive. This allows the weight compensation device to be easily adjusted to the weight it needs to absorb. This allows loads of varying weight to be held and moved with the work apparatus. Furthermore, the weight compensation device can be adjusted to the transfer of force from the load to the work apparatus which varies as the load changes position, even in different settings and positions.

The gripper is expediently movable with respect to the base body together with the load in the direction of gravity of the load and/or in at least one positioning direction. The positioning direction runs in a plane transversely, in particular perpendicularly to the direction of gravity. In particular, the drive device is configured to move the gripper together with the load in the positioning direction and/or in the direction of gravity. The drive device expediently comprises at least one positioning drive for moving the gripper in the positioning direction and/or at least one elevation drive for moving the gripper together with the load in the direction of gravity. This means that the gripper can be moved together with the load in all three spatial directions. Provision may also be made for the drive device to comprise at least one, in particular three rotary drives for rotation around rotary axes. In particular, the positioning drive and/or the elevation drive and/or the rotary drive is an electric motor, in particular a servomotor. This makes the positioning drive and/or the rotary drive and/or the elevation drive particularly easy to control. In particular, the elevation drive is a second actuator. The rotary drive and/or the positioning drive are expediently also each a second actuator.

In an advantageous embodiment of the invention, the work apparatus comprises a displacement sensor. The displacement sensor detects the position of the gripper, in particular of the load, at least indirectly, in particular directly. The detected position is expediently transmitted to the control unit as a position value. Advantageously, the work apparatus, in particular the control unit, regulates the application of force by the weight compensation device depending on the position value. The work apparatus can be configured so that the weight compensation device has to apply different forces to absorb the same force component of the weight of the load, depending on the position of the load.

Expediently, the work apparatus comprises a weight measuring device. The weight measuring device is used to determine the weight of the load at least indirectly. In particular, the weight value is fed to the control unit.

The application of force by the weight compensation device is expediently adjusted so that at least 80%, in particular at least 90%, in particular at least 95%, in particular at least 98%, advantageously at least 99% of the weight of the load, in particular of the load and of the work apparatus, is absorbed by the balance unit, in particular by the weight compensation device. Provision may also be made for the application of force by the weight compensation device to be set so that 100% of the weight of the load, in particular of the load and of the work apparatus, is absorbed by the balance unit, in particular by the weight compensation device. In particular, the application of force by the weight compensation device is regulated depending on the weight of the load. This is done in particular by the control unit. This means that the drive device has to absorb little or no weight of the load to position the gripper together with the load. This allows the drive device to work with small, precise drives. The drive device's small, lower-power drives enable reliable positioning by the work apparatus. The weight compensation device does not have to participate in moving the gripper and/or the load and is therefore less prone to faults.

In an advantageous refinement of the invention, the work apparatus is configured so that the gripper is optionally manually positionable by a worker or is at least partially, in particular completely, automatically movable by means of the drive device. In particular, the work apparatus has a first operating mode and a second operating mode.

In the first operating mode of the work apparatus, the gripper together with the load is movable at least partially automatically by means of the drive device without the assistance of force applied by the worker. In particular, the drive device can be directed by the control unit here. While being moved by the drive device, the weight compensation device absorbs at least some of the weight of the load. The first operating mode corresponds to the above-described automatic movement of the gripper together with the load by means of the drive device while simultaneously absorbing at least some of the weight of the load through the weight compensation device.

In the second operating mode, the gripper together with the load is manually positionable by a worker. During manual positioning of the gripper together with the load, the weight compensation device absorbs at least some of the weight of the external load. This allows the worker to position even large loads manually with little effort.

Because the gripper together with the load are optionally positionable manually by a worker or are movable at least partially automatically by means of the drive device, the advantages of human sensor technology can be exploited during manual positioning. The worker can intervene in the process at any time and make a manual correction. However, it is at the same time also possible for the work apparatus to move the load automatically. This is advantageous, for example, if the gripper is to be moved repeatedly to feed the load in the process or if the worker is needed to work elsewhere.

Advantageously, when being manually positioned by a worker, the drive device is separated from the gripper via a free-wheel due to the force exerted by the worker so that no force is transferred between the drive device and the gripper. In particular, the free-wheel allows a motor shaft of the drive device to rotate freely during manual positioning by the worker due to the force exerted by the worker. The free-wheel enables manual positioning by the worker. This allows the work apparatus to be operated optionally in the first operating mode or in the second operating mode.

In particular, the displacement sensor detects the position of the gripper, in particular of the load, during manual positioning by the worker and transmits it as position values to the control unit. The control unit expediently links the position values to time values. This allows manual positioning to be used to train the work apparatus for automatic operation. In an advantageous refinement of the invention, the control unit is configured to use the detected position values, and in particular the time values associated therewith, and in particular the value of the weight of the load, to independently determine how the drive device is to be controlled during at least partial automatic movement of the gripper. In particular, position values, and in particular time values, and in particular values for the weight, are fed to the control unit while the worker manually moves the gripper with the load several times from a starting position to an end position. The control unit expediently determines herefrom how the drive device is to be directed with at least partial automatic movement of the gripper in order to move the load by means of the gripper from the starting position to the end position, in particular to position the load by means of the gripper in the end position.

In an advantageous embodiment of the invention, the weight compensation device comprises a cylinder with a piston rod and a cylinder housing. The piston rod is displaceable in the cylinder housing in an extension direction. The weight compensation device, in particular the cylinder housing, is expediently supported on a rail of the work apparatus so that it can be moved longitudinally such that the extension direction is always parallel to the direction of the weight of the load. In particular, the gripper is supported pivotably on a pivot arm. The pivot arm is pivotable about a pivot axis. The pivot axis divides the pivot arm into a load part and a drive part. The gripper is assigned to the load part. The gripper is expediently held at least indirectly on the pivot arm. The weight compensation device engages the pivot arm in the drive part of the pivot arm. The pivot axis preferably runs horizontally. Because the weight compensation device, in particular the cylinder housing, is supported on the rail of the work apparatus so that it can be moved longitudinally such that the extension direction is always parallel to the direction of the weight of the load, the torque generated by the weight compensation device on the pivot arm is always the same given a constant force applied by the weight compensation device. If the load remains constant, the force to be applied by the weight compensation device does not need to be adjusted to the different positions of the gripper, in particular of the load. The force to be applied by the weight compensation device only needs to be adjusted to the load once and then always absorbs the same proportion of the weight of the load.

In particular, the drive device and/or the weight compensation device is configured so that it can be operated at an extra-low voltage. The extra-low voltage for alternating voltage is no more than 50 V. The extra-low voltage for direct voltage is no more than 120 V. In particular, the work apparatus comprises a transformer. The transformer converts the mains voltage, specifically 120 V at 60 Hz or 230 V at 50 Hz, into an extra-low voltage. In particular, the work apparatus is configured so that it only needs to be connected to the public power grid for operation, specifically to a power grid with a mains voltage of 120 V at 60 Hz or 230 V at 50 Hz. In particular, the drive device is operable with a voltage of 48 V. In particular, the weight compensation device is configured so that it is operable with the mains voltage or a lower voltage.

The method according to the invention for operating a work apparatus for holding and moving an external load provides for the work apparatus to comprise a weight compensation device whose application of force is adjustable. In particular, the application of force by the weight compensation device is adjustable by means of the control unit. The drive device is directed by the control unit so that the gripper together with the load is automatically moved, in particular positioned, by the drive device. During the automatic movement of the gripper together with the load, at least some of the weight of the external load is absorbed by the weight compensation device. In particular, the application of force by the weight compensation device is adjusted so that at least 95%, in particular at least 99%, of the weight of the load, in particular of the load and of the work apparatus, is compensated for by the balance unit, in particular by the weight compensation device. This balances the work apparatus, and only a small amount of force is required to move the gripper together with the load. This force can be applied by the drive device.

The above-described properties of the work apparatus are also refinements of the method.

### BRIEF DESCRIPTION OF THE DRAWINGS

An exemplary embodiment of the invention is described in more detail below with reference to the drawing, in which:

FIG. 1 shows a schematic side view of a work apparatus for lifting and moving an external load,

FIG. 2 shows a schematic enlarged detailed view of the arrangement from FIG. 1, and

FIG. 3 shows a schematic sketch of the work apparatus for lifting and moving an external load from FIG. 1.

### DETAILED DESCRIPTION

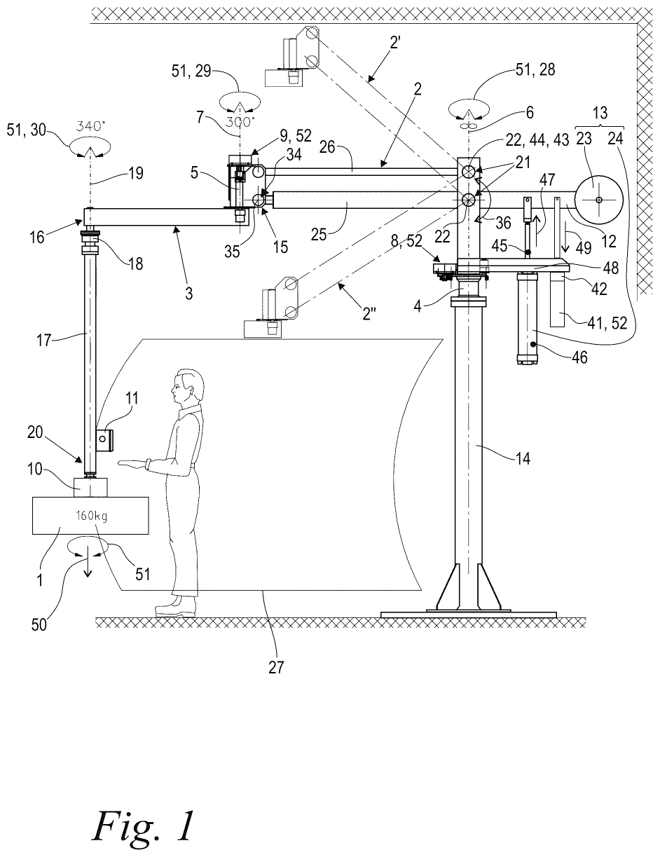

FIG. 1 shows a work apparatus for lifting and moving an external load 1. The work apparatus comprises a base body 14. The base body 14 is arranged to be three-dimensionally fixed. The base body 14 is firmly anchored to the floor. In the exemplary embodiment, the base body 14 is designed as a support column. In the exemplary embodiment, the base body 14 has an elongated shape and extends in the direction of gravity 50.

The work apparatus comprises a gripper 10. The gripper 10 serves to hold the load 1. The load 1 can be picked up and moved by means of the gripper 10. The gripper 10 is intended for gripping or holding the load 1. The gripper 10 can also perform additional functions such as tilting, pivoting or the like on the load 1. The gripper 10 is at least indirectly mechanically connected to the base body 14. In the exemplary embodiment, the gripper 10 is connected to the base body 14 via arms 2, 3. In particular, a vertical pivot arm 17 is arranged between the arms 2, 3 and the gripper 10. The vertical pivot arm 17 connects the gripper 10 directly to the arms 2, 3. However, provision may also be made for the gripper to be connected to the base body via a cable pulley or the like. The gripper 10 is movable relative to the base body 14.

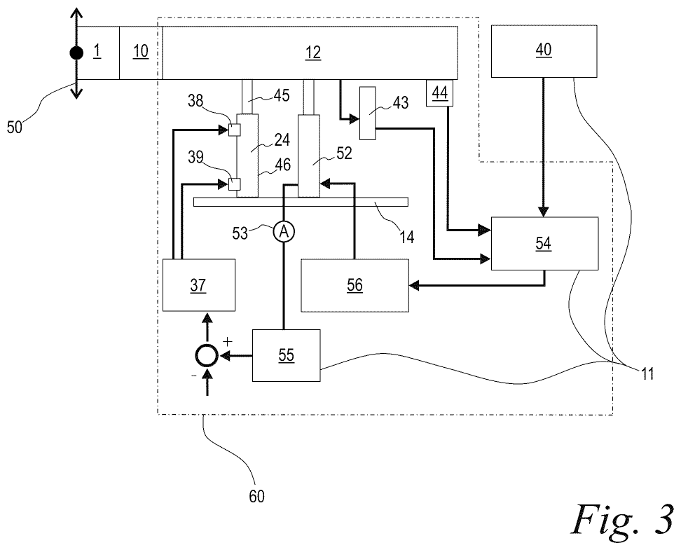

For the movement of the gripper 10 together with the load 1, the work apparatus has at least one drive device 52. The drive device 52 is shown schematically in FIG. 3. In FIG. 1, the drive device 52 comprises a plurality of drives. The positioning drives 8 and 9 serve to position the gripper 10 together with the load 1 with respect to a direction perpendicular to the direction of gravity 50. The elevation drive 41 serves to position the gripper 10 together with the load 1 in the direction of gravity 50. In the exemplary embodiment, the drive device 52 comprises the positioning drives 8 and 9 and the elevation drive 41.

In the exemplary embodiment shown, a positioning drive 8, 9 is arranged in the area of each of the two pivot joints 4, 5 for pivoting the respective arm 2, 3 about the respectively assigned pivot axis 6, 7.

The work apparatus comprises a control unit 11. The control unit 11 serves at least to control the drive device 52. The gripper 10 together with the load 1 is movable by the control unit 11 at least partially automatically by means of the drive device 52. In this context, automatic means that the operator does not have to operate the control unit 11 during the movement. In particular, the operator does not have to exert any physical force to move the gripper 10 and/or the load 1. The positioning of the gripper 10 and/or the load 1 is in particular carried out exclusively by the control unit 11 and the drive device 52. The control unit 11 controls the drive device 52 so that the gripper 10 together with the load 1 is automatically moved from a first position to a second position. In particular, the gripper 10 together with the load 1 is in this way movable, in particular positionable, fully automatically from a starting position of the gripper 10 into an end position of the gripper 10.

The work apparatus comprises a weight compensation device 24. The weight compensation device 24 serves to absorb at least some of the weight 21 of the external load 1. In particular, the weight compensation device 24 serves to absorb at least some of the weight 21 of the external load 1 during the automatic movement of the load 1 by means of the drive device 52. The weight compensation device 24 is designed separately from the drive device 52. The components of the drive device 52 are components which are designed separately from the components of the weight compensation device 24. The application of force by the weight compensation device 24 is adjustable. In particular, the application of force by the weight compensation device 24 is adjustable by means of the control unit 11. In particular, the application of force by the weight compensation device 24 is adjustable by a motor drive.

In the exemplary embodiment, the work apparatus comprises a counterweight 23. The counterweight 23 compensates for at least some of the weight of the load 1, in particular of the work apparatus and of the load 1. In the exemplary embodiment, the counterweight 23 is part of a balance unit 13. The balance unit 13 comprises the weight compensation device 24.

The balance unit 13, in particular the weight compensation device 24, absorbs at least 90%, in particular at least 95%, in particular at least 98%, in the exemplary embodiment at least 99% of the weight of the load 1. The balance unit 13, in particular the weight compensation device 24, absorbs in particular at least 90%, in particular at least 95%, in particular at least 98%, in the exemplary embodiment at least 99% of the weight of the load 1 and of the work apparatus. Provision may also be made for the balance unit 13, in particular the weight compensation device 24, to absorb 100% of the weight of the load 1, in particular of the weight of the load 1 and of the work apparatus. In this case, the weight of the work apparatus refers to the force acting in the direction of gravity 50 and exerting a torque on the components of the work apparatus that are movable in the direction of gravity 50 relative to the base body 14. The sum of the weight of the work apparatus and the weight of the load 1 can be compensated for in the specified proportions by the weight compensation device 24.

The weight compensation device 24 is configured so that it can absorb the weight of an external load 1 weighing at least 10 kg, in particular at least 30 kg, in particular at least 100 kg, in the exemplary embodiment at least 150 kg. The weight compensation device 24 is configured so that it can absorb the weight of an external load 1 and of the work apparatus weighing at least 10 kg, in particular at least 30 kg, in particular at least 100 kg, in the exemplary embodiment at least 150 kg. The weight compensation device 24 is configured so that it can absorb a force of at least 100 N, in particular at least 300 N, in particular at least 1000 N, in the exemplary embodiment at least 1500 N.

In the exemplary embodiment, the weight compensation device 24 can exclusively cause a movement of the gripper 10 in the direction of gravity 50 or against the direction of gravity 50. However, during operation of the work apparatus, the weight compensation device 24 is not intended to the move the gripper 10 and/or the load 1, but merely to compensate as far as possible for the weight of the load 1. During operation of the work apparatus, the gripper 10 and/or of the load 1 is moved primarily, in particular exclusively, by means of the drive device 52. In particular, during operation of the work apparatus, the gripper 10 and/or of the load 1 is not moved primarily by the weight compensation device 24.

As shown in FIG. 1, the weight compensation device 24 directly engages a structural element 12 of the work apparatus. In the exemplary embodiment, the structural element 12 is the arm 2. However, provision may also be made for the structural element 12 to be the cable of a cable pulley or a similar structural element. The structural element 12 is designed in one part. At least part of the drive device 52 also directly engages on exactly the same structural element 12 as the weight compensation device 24. The gripper 10 can be moved in the direction of gravity 50 or against the direction of gravity 50 in load-free operation both solely by the weight compensation device 24 and solely by the drive device 52.

The first arm 2 is fixedly supported on the base body 14 by means of a horizontal pivot joint 21. The horizontal pivot joint 21 has a horizontal pivot axis 22. The first arm 2 is pivotable about the horizontal pivot axis 22. The horizontal pivot joint 22 divides the first arm 2 into a part facing the load 1 and a part facing away from the load 1. The weight compensation device 24 acts in the direction of a pivoting movement about the horizontal pivot axis 22. A part of the drive device 52 also acts in the direction of a pivoting movement about the horizontal pivot axis 22. In the exemplary embodiment, the elevation drive 41 of the drive device 52 acts in the direction of the pivoting movement about the horizontal pivot axis 22. In the exemplary embodiment, both the elevation drive 41 of the drive device 52 and the weight compensation device 24 are arranged in the part of the first arm 2 which is facing away from the load 1.

The weight compensation device 24 comprises a drive. In the exemplary embodiment, the weight compensation device 24 consists of a single drive. The weight compensation device 24 comprises a motor and is a motor in the exemplary embodiment. In the exemplary embodiment, the weight compensation device 24 is a pneumatic drive. The weight compensation device 24 comprises a pneumatic cylinder. However, provision may also be made for the weight compensation device 24 to be a hydraulic drive. In this case, the weight compensation device 24 comprises a hydraulic cylinder. Alternatively, provision may be made for the weight compensation device 24 to be an electric drive, in particular an electric motor. Provision may also be made for the weight compensation device 24 to comprise a pneumatic and/or a hydraulic cylinder and/or an electric drive.

The gripper 10 is movable at least partially automatically by means of the drive device 52 without the assistance of force applied by a worker. The gripper 10 is positionable by the control unit 11 into an end position of the gripper 10 by means of the drive device 52. In the exemplary embodiment, the gripper 10 is movable, in particular positionable, fully automatically by the control unit 11 from a starting position of the gripper 10 into an end position of the gripper 10. The work apparatus is configured so that the gripper 10 moves the load 1 fully automatically to a position specified by the control unit 11 without the assistance of force applied by the worker. In particular, the gripper 10 is positioned exclusively by the control unit 11 and the drive device 52.

The force that can be applied by the drive device 52 to move the gripper 10 and/or the load 1 is no more than 80 N, in particular no more than 700 N, in particular no more than 500 N, in the exemplary embodiment no more than 150 N. The force that can be applied by the drive device 52 to move the gripper 10 and/or the load 1 is at least 10 N, in particular at least 20 N, in the exemplary embodiment at least 30 N. The force that can be applied by the drive device 52 to move the gripper 10 and/or the load 1 is no more than 60%, in particular no more than 40%, in the exemplary embodiment no more than 20% of the maximum force that can be applied by the weight compensation device 24. The maximum force that can be applied by the weight compensation device 24 is at least 100 N, in particular at least 300 N, in particular at least 1000 N, in the exemplary embodiment at least 1600 N.

The gripper 10 together with the load 1 is movable with respect to the base body 14 in the direction of gravity 50 of the load 1 and/or in at least one positioning direction 51. The positioning direction 51 runs in a plane transversely, in the exemplary embodiment perpendicularly to the direction of gravity 50. The drive device 52 is configured to move the gripper 10 together with the load 1 in the positioning direction 51 and/or in the direction of gravity 50. In addition, a rotary drive can be provided for rotation about an axis of rotation 19 of the gripper 10. In the exemplary embodiment, the axis of rotation 19 runs in the direction of gravity 50. The axis of rotation 19 runs through the gripper 10. Provision may be made for the rotary drive to be part of the drive device. The positioning drives 8 and 9 serve to move the gripper 10 together with the load 1 in the positioning direction 51. The drive device 52 comprises at least one positioning drive 8, 9, in the exemplary embodiment at least the two positioning drives 8 and 9. The elevation drive 41 serves to move the gripper 10 together with the load 1 in the direction of gravity 50 and against the direction of gravity 50. The drive device 52 comprises at least the elevation drive 41 to move the gripper 10 together with the load 1 in the direction of gravity 50 and in the direction opposite to the direction of gravity 50. The positioning drive 8, 9 is an electric motor, in the exemplary embodiment a servomotor. The elevation drive 41 is an electric motor, in the exemplary embodiment a servomotor. The optionally provided rotary drive is an electric motor, in particular a servomotor. Additional rotary drives can be provided for rotation about two further axes of rotation, these then being in particular electric motors, in particular servomotors.

The elevation drive 41 is designed separately from the weight compensation device 24. The elevation drive 41, designed as an electric motor, is designed separately from the weight compensation device 24, designed as a pneumatic drive.

As shown in FIG. 1, the work apparatus for lifting and moving the external load 1 comprises a plurality of arms 2, 3. The plurality of arms 2, 3 are movable relative to one another, in particular pivotable with respect to one another. This defines a plurality of movement axes of the work apparatus.

The vertical pivot arm 17 is also an arm. The arms 2, 3, 17 mechanically connect the gripper 10 to the base body 14. The arms 2, 3, 17 are exclusively intended for the mechanical connection between the base body 14 and the gripper 10. An arm can comprise a plurality of components, however, in each case only components which are functionally assigned to the same movement axis and are movable together in the same direction of movement.

As a movement axis, the work apparatus has at least the pivot axis 22, this being horizontally oriented in the exemplary embodiment. In the exemplary embodiment, an additional pivot axis 35 is provided. The pivot axis 35 is, in particular, horizontally oriented. The pivot axis 35 is assigned to a pivot joint 34. The pivot joint 34 is functionally arranged between the arm 2 and the arm 3. The pivot joint 34 enables relative movement, in particular pivoting, of arm 2 and arm 3 with respect to one another.

The movement axes in the exemplary embodiment also include a vertical pivot axis 6, a vertical pivot axis 7 and the axis of rotation 19.

The first arm 2 is fixedly supported by means of an assigned pivot joint 4. In particular, the arm 2 is supported on the support column 14 by means of the vertical pivot joint 4. The pivot joint 4 has the vertical pivot axis 6, also aligned in the direction of gravity, around which the first arm 2 can pivot according to a double arrow 28. No pivot angle limitation is provided here, so the load 1 can be moved into any three-dimensional position around the support column 14. However, a pivot angle limitation can also expediently be provided. The second arm 3 is supported on a free end 15 of the first manipulator arm 2 by means of an assigned pivot joint 5. The second pivot joint 5 has the vertical pivot axis 7 aligned in the direction of gravity 50. The second arm 3 is a pivot arm which is pivotable relative to the first arm 2 about the pivot joint 5 according to a double arrow 29, a rotation angle limitation of a total of 300° being provided in the exemplary embodiment. However, a rotation angle limitation can also be omitted. The second arm 3 is also referred to as a horizontal pivot arm.

Opposite the pivot joint 5, at a free end 16 of the second arm 3, a further pivot joint 18 with the vertical axis of rotation 19 is arranged. The vertical pivot arm 17 is fastened to the second arm 3 by means of the pivot joint 19. Provided in the further pivot joint 18 is a rotation angle limitation of a total of 340° about which the vertical pivot arm 17 is pivotable according to a double arrow 30. A rotation angle limitation can be omitted here too. Opposite the pivot joint 18, the vertical pivot arm 17 has a free end 20 at which is arranged the schematically indicated gripper 10 for the likewise schematically indicated load 1. The pivot joint 18 can also be arranged between the vertical pivot arm 17 and the gripper 10.

The positioning direction 51, which runs in a plane transversely, in the exemplary embodiment perpendicularly, to the direction of gravity 50, can result, in the exemplary embodiment, from a pivoting movement along the double arrow 28 and/or along the double arrow 29 and/or along the double arrow 30. The movement in the positioning direction 51 can be a superposition of a plurality of pivoting movements.

The first arm 2 is assigned to the horizontal pivot axis 22 and is pivotable about it. The first arm 2 is assigned to the vertical pivot axis 6 and is pivotable about it.

At least one of the arms 2, 3, 17 is equipped with two separate actuators. One of the actuators serves to compensate for the weight of the load 1 and the other of the actuators serves to move the load. Provision may also be made for a plurality of arms 2, 3, 17 each to be equipped with two separately designed actuators, one of which serves to compensate for the weight of the load 1, in particular of the load 1 and of the work apparatus, and the other serves to move the load 1, in particular the load 1 and the work apparatus together with the gripper 10. This basic principle is to be viewed independently of the specific exemplary embodiment. In principle, each arm 2, 3, 17 can have an actuator to absorb the weight of the load 1 and a further actuator to move the gripper 10 together with the load 1.

The first actuator and the second actuator are functionally assigned to the same movement axis. In the exemplary embodiment, the first actuator is formed by the weight compensation device 24 acting on the first arm 2. By means of the first actuator, a motor-driven movement of the first arm 2 around the horizontal pivot axis 21 is possible. The first actuator is used to balance the work apparatus, in particular the work apparatus together with the load 1. Actual movement by the first actuator is not intended. The first actuator absorbs at least some of the weight of the load 1, in particular of the load 1 and of the work apparatus 1. In particular, 99% of the weight of the load 1, in particular of the load 1 and of the work apparatus, is compensated for by the first actuator and the counterweight 23 in the exemplary embodiment. The first actuator acts on the first arm 2 so that the resulting torque on the first arm 2 with respect to the horizontal pivot axis 22 is as small as possible. In particular, the resulting torque is less than 4600 Nm, in particular less than 1000 Nm, in particular less than 500 Nm, in particular less than 100 Nm, in the exemplary embodiment less than 50 Nm. In the exemplary embodiment, this is achieved by a single drive of the weight compensation device 24, and in particular the counterweight 23.

The weight compensation device 24, which serves to compensate for at least some of the weight of the load 1, in particular of the load 1 and of the work apparatus, engages on the first arm 2. In the exemplary embodiment, provision is made for the weight compensation device 24 together with the counterweight 23 to compensate for at least 99% of the weight of the load 1, in particular of the load 1 and of the work apparatus. Due to the weight compensation device 24 alone, the load 1 is almost in a kind of suspended state.

The arms 2, 3, 17 are also referred to as structural elements 2, 3, 17. The base body 14 is mechanically connected by means of at least one structural element 2, 3, 17 to the gripper 10 for lifting and moving of the gripper 10 together with the load 1. The gripper 10 can be moved together with the load 1 in a direction of movement by moving the at least one structural element 2 relative to the base body 14.

The weight compensation device 24 comprises the at least one first actuator. The drive device 52 comprises at least one second actuator 41. In the exemplary embodiment, the elevation drive 41 is a second actuator. The second actuator is therefore also designated by the reference numeral 41. In the exemplary embodiment, the weight compensation device 24, which consists of a drive, is a first actuator. The first actuator is therefore also designated by the reference numeral 24.

Both the first actuator 24 and the second actuator 41 act directly on the at least one structural element 2. In particular, both the first actuator 24 and the second actuator 41 are directly supported on the at least one structural element 2. Both the first actuator 24 and the second actuator 41 are at least indirectly supported on the base body 14, in particular at least indirectly mechanically connected to the base body 14.

Both the first actuator 24 alone and the second actuator 41 alone can act on the at least one structural element 2 such that a force acts on the structural element 2 in the same direction of movement on the at least one structural element 2 through the first actuator 24 alone or through the second actuator 41 alone. In the exemplary embodiment, the direction of movement is the circumferential direction 36, which runs around the horizontal pivot axis 22 and is indicated in FIG. 1 by a double arrow. In the exemplary embodiment, both the first actuator 24 alone and the second actuator 41 alone can cause a pivoting movement of the structural element 2 around the horizontal pivot axis 35.

Both the first actuator 24 alone and the second actuator 41 alone can act on the at least one structural element 2 such that a force acts on the at least one structural element 2 through the first actuator 24 alone or through the second actuator 41 alone with respect to the same movement axis, in the exemplary embodiment with respect to the horizontal pivot axis 22.

In the exemplary embodiment, a plurality of structural elements 2, 3, 17 are arranged between the base body 14 and the gripper 10. The plurality of structural elements 2, 3, 17 are movable relative to one another, in particular pivotable relative to one another via the various joints 4, 5, 18, 21, 34. Provision may be made for each structural element 2, 3, 17 to be assigned a first actuator and a second actuator. In the exemplary embodiment, this is only the case for the first structural element 2.

On each structural element 2, 3, 17 of the work apparatus which is movable relative to a directly adjacent structural element 2, 3, 17 connected by a joint by means of the joint in a plane which contains the direction of gravity 50, a mechanically supporting device which mechanically couples the two adjacent structural elements 2, 3, 17 to one another and/or at least a first actuator of the weight compensation device 24 and at least a second actuator 41 of the drive device 52 is provided in order to prevent such a movement of the structural element 2, 3, 17. The mechanical support device may, for example, be a joint which does not permit any movement of the structural element 3 which is functionally further away from the base body 14 relative to the directly adjacent structural element 2 which is arranged functionally closer to the base body 14 in the direction of gravity 50.

As described, the two actuators 24 and 41 can each exert a force on the structural element 2 which acts in the same direction of movement. In the exemplary embodiment, the direction of movement runs along a plane which contains the direction of gravity 50. Provision may be made for the two actuators 24 and 41 to connect the two adjacent components 2, 3, 17 at least indirectly, in particular directly.

In the exemplary embodiment, the arm 2 comprises a coupling 26 and a lifting arm 25. In the exemplary embodiment shown, the arm 2 is formed by a pair of vertically pivotable parallelogram arms arranged one above the other in the direction of gravity 50, the pivot joint 21 being a double joint for the two parallelogram arms. Such a double joint is also provided opposite in the area of the second pivot joint 5. This allows height adjustment of the arm 2, including the gripper 10, in particular including the load 1, from the middle position shown in the drawing to an upper end position, designated 2′, and a lower end position, designated 2″, with any intermediate positions. In the exemplary embodiment, the upper parallelogram arm is the coupling 26. The lower parallelogram arm is the lifting arm 25.

The combination of the horizontal and vertical pivoting results in a schematically indicated envelope 27, within which the free end 20 of the vertical pivot arm 17 or the gripper 10 and the load 1 can be moved, the radially outer pivot axes 7, 19 always maintaining their vertical orientation. The envelope 27 runs as a body of rotation around the pivot axis 6 or around the base body 14. The radially inner arm 2 thus performs a dual function as a horizontally movable pivot arm and as a vertically movable lifting arm.

In addition, moment compensation means are provided which keep the entire arrangement, including the load 1 around the pivot axes 22, at least approximately free from external weight moments. For this purpose, the lifting arm 25 is guided from the free end 15 beyond the central pivot joint 21 and carries the counterweight 23 at its end opposite the free end 15.

In the exemplary embodiment, the drive of the weight compensation device 24 also engages on the lifting arm 25 of the first arm 2 on the same side as the counterweight 23. The weight of the counterweight 23 and the holding force of the weight balancing device 24 are dimensioned such that they form a counter-moment around the pivot axis 22 which is in equilibrium with the weight moment of the arrangement in the area of the arms 2, 3 and of the load 1. To raise or lower the load 1, accordingly only a small force needs to be applied which is sufficient to overcome the mass inertia and the friction moments in the pivot joints. Furthermore, since all pivot joints 4, 5, 18 with their vertical pivot axes 6, 7, 19 are naturally free of external weight moments acting around the vertical pivot axes 6, 7, 19, the above also applies equally to the force for generating a horizontal movement of the gripper 10, in particular of the gripper 10 together with the load 1.

The parallelogram arms, in particular the coupling 26, ensure that the externally connected assemblies, including one or more further pivot joints 5, 18, 34, do not tilt during a height adjustment. The vertical pivot axis 5, 19 of an outer pivot joint remains vertical and thus free from external weight moments.

The coupling 26 is a mechanical support device which mechanically couples the two adjacent structural elements 2, 3 to one another. At the same time, the coupling 26 is part of the structural element 2. The mechanical support device prevents movement of the structural element 3 about the pivot axis 35 relative to the structural element 2 in the direction of gravity 50. The support device ensures that the structural element 3 moves relative to the structural element 2 no more in the direction of gravity 50 than so as to be just barely horizontally aligned.

However, provision may also be made for the arm 2, in particular the structural element 12, to be monolithically designed. In particular, the arm 2, in particular the structural element 12, is formed from a single arm, in particular designed from the same material.

In the exemplary embodiment, the weight compensation device 24 is formed by a pneumatic drive. The pneumatic drive comprises a cylinder housing 46 and a piston rod 45. The piston rod 45 is extendible from the cylinder housing 46 in an extension direction 47. The extension movement is effected pneumatically. In the exemplary embodiment, the extension direction 47 runs parallel to the direction of gravity 50. This allows the weight compensation device 24 to absorb the weight of the load 1 particularly efficiently. However, provision may also be made for the weight compensation device 24 to act in a direction oblique to the direction of gravity 50. In addition, provision may be made for the weight compensation device 24 alternatively or additionally to comprise a hydraulic and/or electric drive. In principle, provision may be made for the weight compensation device 24 to consist of a plurality of similar and/or different drives. The second actuator, which acts on the arm 2, is the elevation drive 41 of the drive device 52 in the exemplary embodiment. In the exemplary embodiment, the elevation drive 41 is an electric motor. However, provision may also be made for the elevation drive to be a pneumatic or hydraulic drive.

Both the first actuator alone, designed as a pneumatic drive in the exemplary embodiment, and the second actuator 41 alone, designed as an electric drive in the exemplary embodiment, act on the same structural element, in the exemplary embodiment on the arm 2, such that the first actuator alone or the second actuator 41 alone exerts a force on the structural element 2 which can trigger a movement of the structural element 2 in the same direction of movement 36 of the structural element 2. In the exemplary embodiment, the weight compensation device 24, in particular the pneumatic drive of the weight compensation device 24, can cause a pivoting movement of the arm 2 about the horizontal pivot axis 22. In fact, this is not the purpose of the weight compensation device 24. Rather, the weight compensation device 24 is merely intended as far as possible to compensate for the weight of the load 1. But the force which the weight compensation device 24, in particular its pneumatic drive, exerts on the arm 2 acts in the direction of a pivoting movement about the horizontal pivot axis 22. In the exemplary embodiment, the drive device 52 can act on the arm 2 by means of the elevation drive 41 so that the drive device 52, in particular the elevation drive 41, alone exerts a force on the arm 2 which can trigger a pivoting movement of the arm 2 about the horizontal pivot axis 22 in the same pivoting direction of the arm 2 as the weight compensation device 24, in particular its pneumatic drive.

FIG. 3 shows a schematic representation of the described principle of the action of two separately designed actuators 24 and 52 on one and the same structural element 12 of the work apparatus. In the exemplary embodiment, the structural element 12 is the arm 2 which is pivotable about the pivot axis 22. The structural element 12 acts on the gripper 10, in particular so that a force is exerted on the gripper 10, in particular together with the load 1, in the direction opposite to the direction of gravity 50. The structural element 12 may also be used to position the gripper 10, in particular together with the load 1.

The weight of the structural element 12 is compensated for almost exclusively by the weight compensation device 24. The weight compensation device 24 is supported on the base body 14. The base body 14 is arranged to be three-dimensionally fixed. For example, the base body 14 is placed on the floor or bolted to the floor. The drive device 52 is also supported on the base body 14. This can be done indirectly in both cases.

The nominal power of the second actuator of the drive device 52 is no more than 30%, in particular no more than 20%, in particular no more than 10%, in particular no more than 5% of the nominal power of the first actuator of the weight compensation device 24.

The first actuator of the weight compensation device 24 and the second actuator of the drive device 52 are interconnected in terms of control technology such that the second actuator of the drive device 52 must apply the lowest possible force both when the work apparatus is moving and when it is stationary.

The control unit 11 regulates the application of force by the weight compensation device 24, in particular by the first actuator of the weight compensation device 24, in particular all first actuators of the weight compensation device 24, according to a regulation variable of the drive device 52.

The control unit 11 regulates the application of force by the weight compensation device 24, in particular the first actuator of the weight compensation device 24, in particular all first actuators of the weight compensation device 24, so that a variable of the drive device 52, in particular of the second actuator of the drive device 52, in particular of all second actuators of the drive device 52, is below a threshold value. The variable of the drive device 52, in particular of the second actuator of the drive device 52, is also referred to as the operating variable, parameter or key figure of the drive device 52, in particular of the second actuator of the drive device 52. The variable of the drive device 52 may, for example, be the strength of the current flowing through the drive device 52, the drive power of the drive device, the torque of the drive device 52, in particular of the second actuator of the drive device 52, the speed of the drive device 52, in particular of the second actuator of the drive device 52, and/or the force which the drive device 52 must apply to hold and move the load 1. The threshold value is then a current threshold value, a power threshold value, a torque threshold value, a speed threshold value and/or a force threshold value. Regulation is carried out, in particular, so that the measured variable remains below the threshold value. For this purpose, the application of force by the weight compensation device is expediently adjusted. In particular, the measured variable is fed to the control unit 11 and the control unit 11 adjusts the application of force by the weight compensation device 24. In particular, the control unit monitors the development of the measured variable and adjusts the application of force if necessary.

In particular, the control unit 11 regulates the application of force by the weight compensation device 24, in particular by the first actuator, in particular all first actuators of the weight compensation device 24, so that the force which the drive device 52, in particular that of the second actuator, in particular of all second actuators of the drive device 52, must apply to hold and move the load 1, in particular the load 1 and the work apparatus, is below a force threshold value. In particular, the force threshold value is 800 N, in particular 700 N, in particular 500 N, in particular 150 N. These values apply in particular to a single second actuator of the drive device 52. If a plurality of second actuators are provided, the stated values for the force threshold value represent the total sum of all force threshold values of the individual second actuators, that is to say a force threshold value for the drive device 52 as a whole.

In the exemplary embodiment, the regulation variable for the electric drive of the second actuator 52 is the current. The force of the first actuator 24 is regulated so that the drive energy of the second actuator 52, in particular the strength of the electric current with which the second actuator 52 is operated, is minimal.

The control unit 11 regulates the application of force by the weight compensation device 24, in particular by the first actuator, in particular all first actuators of the weight compensation device 24, so that the strength of the current flowing through the drive device 52, in particular through the second actuator, in particular through all second actuators of the drive device 52, to hold and move the load 1 is below a current threshold value. In particular, the current threshold value is 5 A, in particular 3 A, in particular 2 A, in the exemplary embodiment 1 A.

The regulation variable, in the exemplary embodiment the strength of the current flowing through the second actuator, is measured and fed to the control unit 11. Provision may also be made for the total current strength of all second actuators of the drive device 52 to be measured and fed to the control unit 11. In a certain position of the gripper 10, in particular of the load 1, the control unit 11 regulates the force to be applied by the weight compensation device 24, in particular by the one or more first actuators of the weight compensation device 24, so that the total current strength of the one or all second actuators of the drive device 52 is minimal, in particular zero.

To measure the motor current through the drive device 52, the work apparatus comprises an ammeter 53. The ammeter 53 measures the strength of the current with which the second actuator is operated. In particular, the ammeter 53 measures the total strength of all of the currents by means of which the second actuators are operated. The measured value of the ammeter 53 is fed to the control unit 11.

The computational operations required for operation of the work apparatus take place in the control unit 11. The control unit 11 is also referred to as the electronics unit. In the exemplary embodiment, the control unit 11 comprises a guidance controller 40, a position regulator 54, a balance regulator 55 and a pressure regulator 37. The value measured by the ammeter 53 is fed to the balance regulator 55.

The pressure regulator 37 is provided in the exemplary embodiment to adjust the force to be applied by the weight compensation device 24. The weight compensation device 24 designed as a pneumatic cylinder has pneumatic valves 38 and 39. A piston (not shown) is arranged on a piston rod 45 in the cylinder housing 46 of the pneumatic cylinder. The piston hermetically separates two chambers of the cylinder housing from one another. The piston is supported in the cylinder housing 46 displaceably in the longitudinal direction of the cylinder housing 46. A pneumatic valve 38, 39 is arranged on each side of the piston. The pneumatic valve 38 is arranged in a compressed air line between the pressure regulator 37 and the first chamber. The pneumatic valve 39 is arranged in a compressed air line between the pressure regulator 37 and the second chamber. According to a known principle, the pressure regulator 37 can adjust the pressure ratio of the first chamber to the second chamber so that the piston rod 45 exerts a specific force on the structural element 12.

The balance regulator 55 calculates, from the actual motor current value, values which are fed to the pressure regulator 37 and, based thereon, the pressure regulator 37 directs the pneumatic valves 38 and 39 and/or supplies compressed air to at least one chamber of the cylinder housing 46 and/or releases air from at least one chamber of the cylinder housing 46.

In this way, the force acting on the structural element 12 by the weight compensation device 24 is varied until the current value measured by the ammeter 53 is below a current threshold value stored in the control unit 11, in particular in the balance regulator 35. This regulation takes place after each change in the position of the gripper 10, in particular of the load 1.

The control unit 11 can specify a target value for the position of the gripper 1, in particular of the load 1. For this purpose, the control unit 11 comprises the guidance controller 40. The guidance controller 40 specifies the target value for the position of the gripper 1. The target value for the position of the gripper 1 is the reference variable for both the weight compensation device 24 and the drive device 52. Both the weight compensation device 24 and the drive device 52 are regulated based on this reference variable.

The target value for the position of the gripper 1, in particular of the load 1, is transmitted to the position regulator 54 by the guidance controller 40. The position regulator 54 compares the target value for the position of the gripper 1, in particular of the load 1, with an actual value of the position of the gripper 1, in particular of the load 1. From the difference between the target value and the actual value, the position regulator 54 determines a target value for the strength of the current with which the drive device 52, in particular the second actuator, in particular all second actuators, are operated. The target value for the current strength is transmitted by the position regulator 54 in the form of a current signal to a current amplifier 56. The current amplifier 56 amplifies the current signal. The current signal entering the current amplifier 56 as a control signal is transformed here into an operating current with an operating current strength. This current strength is then used to operate the drive device 52, in particular the second actuator, in particular all second actuators.

As described, the actual value of the motor current is measured with the ammeter 53 and, based on this measured value, the force to be applied by the weight compensation device 24, in particular by the first actuator, in particular all first actuators, is determined and adjusted.

Should there be a change in the position of the gripper 1, in particular of the load 1, here the position regulator 54 adjusts the target value for the strength of the current flowing to the drive device 52. The regulation cycle starts again.

The work apparatus comprises a displacement sensor 43. The displacement sensor 43 detects the position of the gripper 10, in particular of the load 1. The position is detected at least indirectly. The detected position value is transmitted from the displacement sensor 43 to the position regulator 54.

The work apparatus is configured so that the gripper 10 is optionally manually positionable by a worker or is at least partially, in particular completely, automatically movable by means of the drive device 52. The work apparatus has a first operating mode and a second operating mode.

In the first operating mode of the work apparatus, the gripper 10 together with the load 1 is movable at least partially automatically by means of the drive device 52 without the assistance of force applied by the worker. The drive device 52 is directed by the control unit here (regulated in the exemplary embodiment). While being moved by the drive device 52, the weight compensation device 24 absorbs at least some of the weight of the load 1, in particular of the load 1 and of the work apparatus. The first operating mode corresponds to the above-described automatic movement of the gripper 1 together with the load 1 by means of the drive device 52 while simultaneously absorbing at least some of the weight of the load 1, in particular of the load 1 and of the work apparatus, through the weight compensation device 24.

In the second operating mode, the gripper 10 together with the load 1 is manually positionable by a worker. During manual positioning of the gripper 1 together with the load 1, the weight compensation device 24 absorbs at least some of the weight of the external load 1, in particular of the load 1 and of the work apparatus.

When being manually positioned by a worker, the drive device 52 is separated from the gripper 10 via a free-wheel 42 (FIG. 1) due to the force exerted by the worker, so that no force is transferred between the drive device 52 and the gripper 10. In particular, the free-wheel 42 allows a motor shaft of the drive device 52 to rotate freely during manual positioning by the worker due to the force exerted by the worker. The free-wheel 42 enables manual positioning by the worker. This allows the work apparatus to be operated optionally in the first operating mode or in the second operating mode.

The first operating mode or the second operating mode is set by the worker actuating the control unit 11. In the exemplary embodiment, the control unit 11 is arranged in the area of the gripper 10 for the load 1, in particular at the free end 20 of the vertical pivot arm 17. The worker has simultaneous access to the load 1 and to the control device 11 here. This enables them to move the load 1 manually and simultaneously call up supporting drive power from the positioning drives 8, 9 by actuating the control device 11, which corresponds to a third operating mode. The control unit 11 can also operate the work apparatus in the fully automatic first operating mode.

Adjusting the height of the load 1 by pivoting around the pivot axes 22 can be carried out fully automatically using the elevation drive 41 in the first operating mode, purely manually in the second operating mode, or by the force applied by the worker supported by the elevation drive 41 in the third operating mode. The elevation drive 41 is used, in particular controlled, and in particular regulated, by the control unit 11.

In the exemplary embodiment, the elevation drive 41 is supported at least indirectly on the base body 14. In the exemplary embodiment, a rail 48 is fixed to the base body 14. The elevation drive is supported directly on the rail 48 via rollers.

The second operating mode can be used to be able to specify a position sequence to the control unit 11, in particular to the guidance controller 40. When the worker manually positions the gripper 1, in particular the gripper 1 together with the load 1, the displacement sensor 43 detects the positions of the gripper 1, in particular of the load 1. The displacement sensor 43 transmits the positions as position values to the control unit 11, in particular to the position regulator 54. The control unit 11 links the position values with time values. Manual positioning in the second operating mode can be used to teach the work apparatus for automatic operation in the first operating mode. The control unit 11 is configured to use the detected position values and the associated time values to independently determine how the drive device 52 and, in particular, the weight compensation device 24, are to be directed during at least partial automatic movement of the gripper 1, in particular together with the load 1.

While the worker manually moves the gripper 0 with the load 1 several times in the second operating mode from a starting position to an end position, position values and time values are fed to the control unit 11. The control unit 11 determines herefrom how the drive device 52 is to be directed with at least partial automatic movement of the gripper 1 in order to move the load 1 by means of the gripper 10 from the starting position to the end position, in particular to position the load 1 by means of the gripper 1 in the end position.

The work apparatus comprises a weight measuring device 44. The weight measuring device 44 serves to at least indirectly determine the weight of the load 1, in particular of the load 1 and of the work apparatus. The value of the weight is fed from the weight measuring device 44 to the control unit 11, in particular to the position regulator 54.

Provision may be made for the control unit 11, in particular the position regulator 54, to be configured so that the value of the weight is used, in particular alternatively or in addition to the position values and/or the time values, to independently determine how the drive device 52 is to be directed during at least partial automatic movement of the gripper 1 in order to move the load 1 by means of the gripper 1 from the starting position to the end position, in particular to position the load 1 by means of the gripper 1 in the end position. In particular, during the repeated manual guidance of the gripper 1 with the load 1 by the worker from the starting position to the end position, the weight values can be recorded by the control unit 11, in particular with time and/or location resolution.

The application of force by the weight compensation device 24 can be regulated by the control unit 11 as a function of the position value of the gripper 10 and/or the weight force value.

Provision may be made for the control unit 11 to direct the weight compensation device 24 in the different height positions of the gripper 10 so that the balance unit 13, in particular the weight compensation device 24, absorbs, in particular compensates for, at least 90%, in particular at least 95%, in particular at least 98%, in the exemplary embodiment at least 99% of the weight of the load 1, in particular of the load 1 and of the work apparatus. Provision may also be made for the control unit 11 to direct the weight compensation device 24 in the different height positions of the gripper 10 so that the balance unit, in particular the weight compensation device 24, absorbs 100% of the weight of the load 1, in particular of the weight of the load 1 and of the work apparatus.

In FIG. 3, a drive unit 60 is marked with a dashed line. The drive unit comprises at least the weight compensation device 24 and the drive device 52.

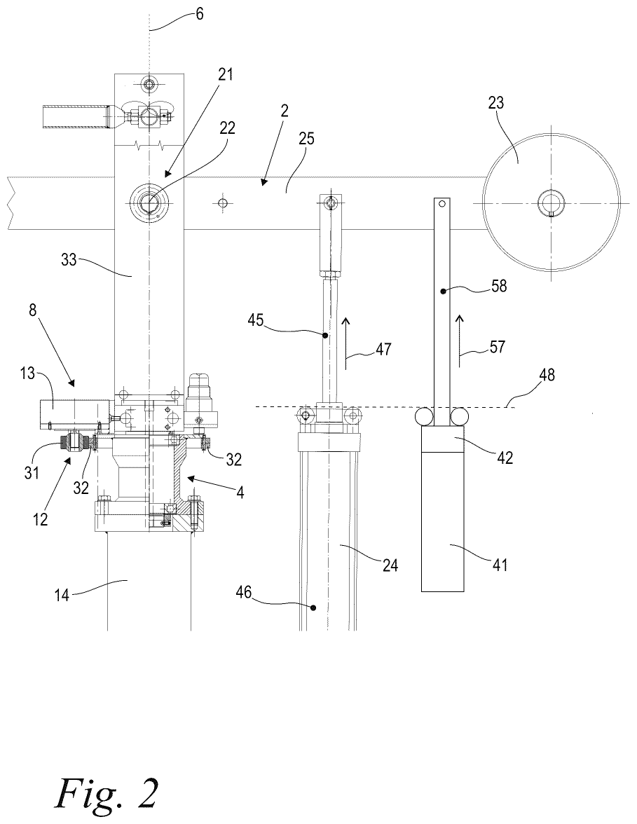

As schematically shown in FIG. 2, the weight compensation device 24, in particular the cylinder housing 46, is supported on a rail 48 of the work apparatus so that it can be moved longitudinally such that the extension direction 47 of the piston rod 45 is always parallel to the direction of gravity 50 of the load 1. In the exemplary embodiment, the cylinder housing 46 is supported on the rail 48 by means of rollers. The rail 48 extends transversely, in the exemplary embodiment perpendicularly, to the direction of gravity 50.

The gripper 10 is at least indirectly pivotably supported on the arm 2. The arm 2 is also referred to as a pivot arm. The arm 2 is pivotable about the horizontal pivot axis 22. The pivot axis 22 divides the arm 2 into a load part and a drive part. The gripper 10 is assigned to the load part. In the exemplary embodiment, the gripper 10 is held indirectly on arm 2. However, provision may also be made for the gripper 10 to be held directly on the pivot arm. The weight compensation device 24 engages on arm 2 in the drive part of arm 2.

In the exemplary embodiment, at least a part of the drive device 52, in particular at least a second actuator (in the exemplary embodiment the elevation drive 41) of the drive device 52, in particular all of the second actuators of the weight compensation device 24, is supported on the rail 48 of the work apparatus so that it can be moved longitudinally such that an extension direction 47 of a piston rod 58 of the drive device 52, in particular of the second actuator (of the elevation drive 41), is always parallel to the direction of gravity 50 of the load 1. In the exemplary embodiment, the second actuator, in particular the elevation drive 41, is designed as an electric cylinder. The electric cylinder has the piston rod 58.

Provision may be made for the drive device 52, in particular the second actuator, in particular all of the second actuators, to operate as generators in the second operating mode.

The work apparatus for holding and moving the external load 1 is operated by means of a method so that the drive device 52 is directed, in particular regulated, by the control unit 11 so that the gripper 10 is automatically moved, in particular positioned, together with the load 1 by the drive device 52, and that meanwhile at least some of the weight of the external load 1, in particular of the load 1 and of the work apparatus, is absorbed by the weight compensation device 24. In the exemplary embodiment, the application of force by the weight compensation device 24 is adjusted, in particular regulated, by means of the control unit 11 so that the force to be applied by the drive device 52 is below a force threshold value. In particular, the force threshold value is 800 N, in particular 700 N, in particular 500 N, in the exemplary embodiment 150 N.

In particular, the drive device 52 and/or the weight compensation device 24 is configured so that it is operable at an extra-low voltage. The extra-low voltage for alternating voltage is no more than 50 V. The extra-low voltage for direct voltage is no more than 120 V. In particular, the work apparatus comprises a transformer. The transformer converts the mains voltage, specifically 120 V at 60 Hz or 230 V at 50 Hz, into an extra-low voltage. In particular, the work apparatus is configured so that it only needs to be connected to the public power grid for operation, in particular to a power grid with a mains voltage of 120 V at 60 Hz or 230 V at 50 Hz. In particular, the drive device 52 is operable at a voltage of 48 V. In particular, the weight compensation device 24 is configured so that it is operable with the mains voltage or a lower voltage.

What is claimed is:

1. A work apparatus for lifting and moving a load (1) having a weight, the work apparatus comprising:
a base body (14);
a gripper (10) for the load (1), the gripper (10) being movable with respect to the base body (14);
a drive device (52) configured to move the gripper (10) together with the load (1);
a control unit (11) for controlling the drive device (52), wherein the gripper (10) together with the load (1) is automatically movable at least in sections by the control unit (11) via the drive device (52); and
a weight compensation device (24) for absorbing at least some of the weight of the load (1),
wherein an application of force by the weight compensation device (24) is adjustable.

2. The work apparatus according to claim 1,
wherein the base body (14) is mechanically connected by at least one structural element (2) to the gripper (10) for lifting and moving the gripper (10) together with the load (1),
wherein a movement of the gripper (10) together with the load (1) can be brought about by moving the at least one structural element (2) relative to the base body (14) in a direction of movement,
wherein the weight compensation device (24) comprises a first actuator,
wherein the drive device (52) comprises a second actuator (41), and
wherein both the first actuator and the second actuator (41) act directly on the at least one structural element (2).

3. The work apparatus according to claim 2,
wherein both the first actuator alone and the second actuator (41) alone can act on the at least one structural element (2) such that a force acts on the structural element (2) in the same direction of movement on the at least one structural element (2) through the first actuator alone or through the second actuator (41) alone.

4. The work apparatus according to claim 2,
wherein a plurality of structural elements are arranged between the base body (14) and the gripper (10),
wherein the plurality of structural elements are movable with respect to one another, and
wherein each structural element is assigned a first actuator and a second actuator.

5. The work apparatus according to claim 1,
wherein the gripper (10) is positionable by the control unit (11) into an end position of the gripper (10) by the drive device (52), and
wherein the gripper (10) is positionable fully automatically from a starting position of the gripper (10) into the end position of the gripper (10).

6. The work apparatus according to claim 1,
wherein the force that can be applied by the drive device (52) to move the gripper (10) is no more than 150 N.

7. The work apparatus according to claim 1,
wherein the weight compensation device (24) is configured so that an external load (1) weighing at least 100 kg can be held by the gripper (10).

8. The work apparatus according to claim 1,
wherein the weight compensation device (24) comprises at least one motor, and
wherein the weight compensation device (24) comprises a pneumatic and/or a hydraulic cylinder and/or an electric drive.

9. The work apparatus according to claim 1,
wherein the gripper (10) is movable with respect to the base body (14) in the direction of gravity (50) of the load (1) and/or a positioning direction (51), the positioning direction (51) running in a plane perpendicularly to the direction of gravity (50), and
wherein the drive device (52) is configured to move the gripper (10) in the positioning direction (51) and/or in the direction of gravity (50).

10. The work apparatus according to claim 9,
wherein the drive device (52) comprises
a positioning drive (8, 9) for moving the gripper (10) in the positioning direction (51) and/or
an elevation drive (41) for moving the gripper (10) in the direction of gravity (50), and
wherein the positioning drive (8, 9) and/or the elevation drive (41) is a servomotor.

11. The work apparatus according to claim 1,
wherein the work apparatus is configured so that the gripper (10) is optionally manually positionable by a worker or is movable at least partially automatically by the drive device (52).

12. The work apparatus according to claim 2,
wherein the control unit (11) regulates the application of force by the first actuator, so that a variable of the second actuator of the drive device (52), is below a threshold value, and regulates it so that a current flowing through the second actuator for holding and moving the load (1) and the work apparatus, is below a current threshold value, and
wherein the current threshold value is 1 A.

13. The work apparatus according to claim 1,
wherein the work apparatus comprises a displacement sensor (43) which detects positions of the load (1), at least indirectly, during manual positioning by a worker, and transmits them to the control unit (11) as position values,
wherein the control unit (11) links the position values to time values, and
wherein the control unit (11) is configured so that it uses the position values, and the time values linked thereto, to determine independently how the drive device (51) is to be directed during at least partial automatic movement of the gripper (10).

14. The work apparatus according to claim 1,
wherein the weight compensation device (24) is part of a balance unit (13) for absorbing the weight of an external load (1), and
wherein the balance unit (13) absorbs at least 98% of the weight of the load (1), and
wherein the control unit (11) directs the weight compensation device (24) into different height positions of the gripper (10) accordingly.

15. A method, comprising:
providing a work apparatus for lifting and moving a load (1) having a weight, the work apparatus with
a base body (14),
a gripper (10) for the load (1), the gripper (10) being movable with respect to the base body (14),
a drive device (52) configured to move the gripper (10) together with the load (1),
a control unit (11) for controlling the drive device (52), wherein the gripper (10) together with the load (1) is automatically movable at least in sections by the control unit (11) via the drive device (52), and
a weight compensation device (24); and
adjusting an application of force by the weight compensation device (24), and
absorbing at least some of the weight of the load (1) by the weight compensation device (24).
